(19) United States
(12) Patent Application Publication
(10) Pub. No.: US 2002/0059154 A1
(43) Pub. Date: May 16, 2002

(54) Method for simultaneously optimizing artificial neural network inputs and architectures using genetic algorithms

(76) Inventor: David M. Rodvold, Colorado Springs, CO (US)

Correspondence Address: SUSAN E.D. CAMPBELL, HOLME ROBERTS & OWEN, L.L.P., SUITE 1300, 90 SOUTH CASCADE AVENUE, COLORADO SPRINGS, CO, 80903, US

(21) Appl. No.: 09/841,961

(22) Filed: Apr. 24, 2001

Related U.S. Application Data
(60) Provisional application No. 60/199,224, filed on Apr. 24, 2000.

(51) Int. Cl. G06F 15/18

(52) U.S. Cl. 706/26; 706/15

(57) ABSTRACT

Artificial Neural Networks (ANNs) are useful mathematical constructs for tasks such as prediction and classification. While methods are well-established for the actual training of individual neural networks, determining optimal ANN architectures and input spaces is often a very difficult task. An exhaustive search of all possible combinations of parameters is rarely possible, except for trivial problems. A novel method is presented which applies Genetic Algorithms (GAs) to the dual optimization tasks of ANN architecture and input selection. The method contained herein accomplishes this using a single genetic population, simultaneously performing both phases of optimization. This method allows for a very efficient ANN construction process with minimal user intervention.

### CROSS REFERENCE TO RELATED APPLICATIONS

This is a non-provisional application which claims priority from provisional application Ser. No. 60/199,224 filed Apr. 24, 2000 by inventor David M. Rodvold and this application is incorporated herein by reference.

### BACKGROUND OF THE INVENTION

### Field of the Invention

The present invention is generally related to the optimization of inputs and architectures of artificial neural networks (ANNs) using genetic algorithms (GAs).

Artificial Neural Networks

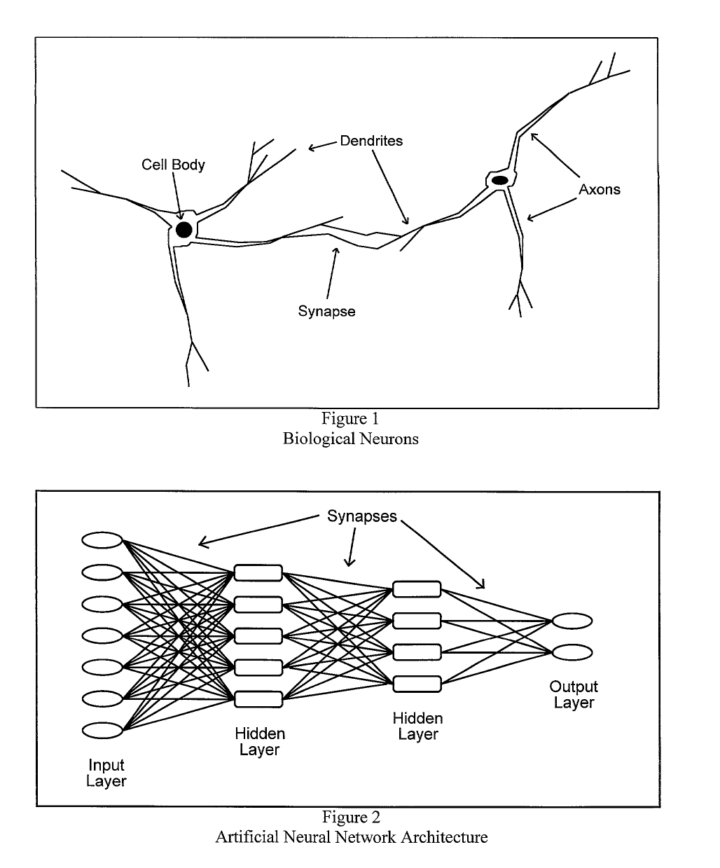

Artificial neural networks are the sole successfully deployed AI paradigm that attempts to mimic the activities of the human brain and how it physically operates. The primary primitive data structure in the human brain is the neuron. There are approximately 10¹¹ neurons in the human brain. Extending from the neurons are tendril-like axons, which carry electrochemical signals from the body of the neuron. Thinner structures called dendrites protrude from the axons, and continue to propagate the signals from the neural cell bodies. Where the dendrites from two neurons meet, interneural signals are passed. These intersection points (about 10¹⁵ of them) are called synapses. FIG. 1 shows a extremely simplified representation of two connected biological neurons.

Artificial neural networks are computer programs that emulate some of the higher-level functions of the architecture described above. As in the human brain, there are neurons and synapses modeled, with various synaptic connection strengths (referred to as weights) for each connected pair of neurons. However, similar to many computer programs (and unlike the brain) there is a specific set of input and output neurons for each problem and each net. These input and output neurons correspond to the input and output parameters of a traditional computer program, and the other neurons, along with the synapses and their weights, correspond to the instructions in a standard program. FIG. 2 shows a representation of a multilayer perceptron artificial neural network. The network shown has 7 input neurons, 2 output neurons, 2 hidden layers, 9 hidden neurons, and 63 synapses (and weights). The matrices of synaptic weights contain the “intelligence” of the system.

The initial network configuration (number of hidden neuron layers, number of hidden neurons in each layer, activation function, training rate, error tolerance, etc.) is chosen by the system designer. There are no set rules to determine these network parameters, and trial and error based on experience seems to be the best way to do this currently. Some commercial programs use optimization techniques such as simulated annealing to find good network architectures. The synaptic weights are initially randomized, so that the system initially consists of “white noise.”

Training pairs (consisting of an input vector and an output vector) are then run through the network to see how many cases it gets correct. A correct case is one where the input vector's network result is sufficiently close to the established output vector from the training pair. Initially the number of correct cases will be very small. The network training module then examines the errors and adjusts the synaptic weights in an attempt to increase the number of correctly assessed training pairs. Once the adjustments have been made, the training pairs are again presented to the network, and the entire process iterates. Eventually, the number of correct cases will reach a maximum, and the iteration can end.

Once the training is complete, testing is performed. When creating the database of training pairs, some of the data are withheld from the system. Usually at least ten percent of the available data are set aside to run through the trained network, testing the system's ability to correctly assess cases that it has not trained on. If the testing pairs are assessed with success similar to the training pairs, and if this performance is sufficient, the network is ready for actual use. If the testing pairs are not assessed with sufficient accuracy, the network parameters must be adjusted by the network designer, and the entire process is repeated until acceptable results are achieved.

Genetic Algorithms

Computer Science researchers have for many years attempted to define numerical methods of minimizing or maximizing functions. Exhaustive search techniques are usually not applicable for problems with more than a few parameters (Goldberg 1989). Such NP-complete or NP-hard problems usually require a method of solution that represents a compromise between level of optimization and computer resources required. In other words, the goal with these numerical approximations is to find a solution that is very good (i.e. close to the true optimum) and that is calculable in an acceptable amount of time using readily-available computing resources.

Genetic algorithms were introduced in the mid-1970's (Holland 1975) by researchers at the University of Michigan. The fundamental concepts that they were trying to capture were natural selection, survival of the fittest, and evolution. To define a numeric model of the evolutionary process, analogues to some biological constructs and processes are required. The primary construct is a structure that allows the parameters of a system to be modeled genetically. In biological systems, the overall genetic package (or genotype) is composed of a set of chromosomes. The individual substructures that comprise the chromosomes are called genes. A single gene can assume a number of values called alleles. The position of a gene within a chromosome is called its locus.

In the computer-based genetic model, one chromosome is often sufficient to characterize a problem space. If two or more subproblems are to be handled in a single larger problem, and are being optimized independently, a chromosome will be required for each one. Computers are able to deal very efficiently with binary numbers, i.e. numbers comprised of a string of ones and zeroes. Thus the alleles in a genetic algorithm are generally limited to binary values. Genes are generally clumped together at contiguous loci to form a single value. For example, if one parameter in a problem needs to be able to take on values from 1 to 25, five binary positions (loci) will be required to store the value (since 2⁵=32 is the smallest power of two greater than or equal to 25).

One can begin to see how a problem's solution space is represented in a genetic algorithm. To define a chromosome, the parameters for the problem (or subproblem) are identified and assigned a binary “size” based on the enumeration of their range of values. For continuous parameters in a problem, a “granularity” must be assigned that limits the number of values that parameter can assume. Infinite variability is not allowed. A chromosome is then constructed by concatenating the binary substrings for the individual parameters into a single longer binary string.

A population of potential solutions can be constructed by assigning random values to the genes. Before accepting them, the values must be checked for legality, e.g. making sure that a value of 29 does not appear in a series of five loci that are intended to contain values from 1 to 25. The size of the population will need to be chosen such that a sufficient number of individuals are available to effectively span the parameter space, but not so large that available computer resources are overwhelmed.

The true power of genetic algorithms lies in the evolution of the population. Individuals within a population combine to form new members, and the “fittest” members are the most likely to become “parents” of new members. The concept of fitness is central to GAs, and one of the most challenging and important tasks associated with implementing a genetic algorithm. In order to determine which individuals pass their genetic information on to subsequent generations, each individual is assessed with a fitness function that defines a numeric value for its desirability. The individuals are then ranked according to their fitness, and the fittest individuals are most likely to reproduce. Thus the GA system designer must be able to quantify numerically how “good” a solution is as a function of its characteristic parameters.

After two individuals are selected for reproduction, the offspring are determined via a process called crossover. The basic concept is that a random position in a chromosome is chosen, and both individuals split into two pieces at that point. The individuals then swap one part of the chromosome with the other individual to form two new individuals. For example, consider the simplified case where two individuals have chromosomes of 1111111 and 0000000. If a crossover point after the third gene is randomly selected, then the two offspring of these two individuals would be 1110000 and 0001111. These new individual then replace their “parents” in the population.

Often, “elitism” is implemented in genetic algorithms, wherein the fittest individuals in a generation (some percentage the population representing the elite of that generation) are allowed to survive unchanged from one generation to the next.

A population can experience change from a source other than reproduction. In particular, spontaneous mutations can occur at a pre-selected probability. If a mutation is determined to have occurred, a new individual is created from an existing individual with one binary position reversed. The processes of reproduction and mutation usually continue for many generations. Common stopping conditions for the process include the passing of a preset number of generations, a static population (no new members displace the old ones) for a certain number of generations, one elite individual has had the highest fitness for a certain number of generations, or a solution has emerged whose quality exceeds some preset metric. When the GA finishes running, the fittest individual in the population represents the (near) optimal solution.

### BRIEF SUMMARY OF THE INVENTION

In constructing effective and accurate ANNs, one of the most difficult tasks is determining which of the available inputs parameters are necessary for the decision-making process. Similarly, defining a network architecture (number of hidden neurons, network connectivity, etc.) is also very challenging. Often, these tasks are performed using “trial-and-error” techniques, and the two tasks are generally performed separately.

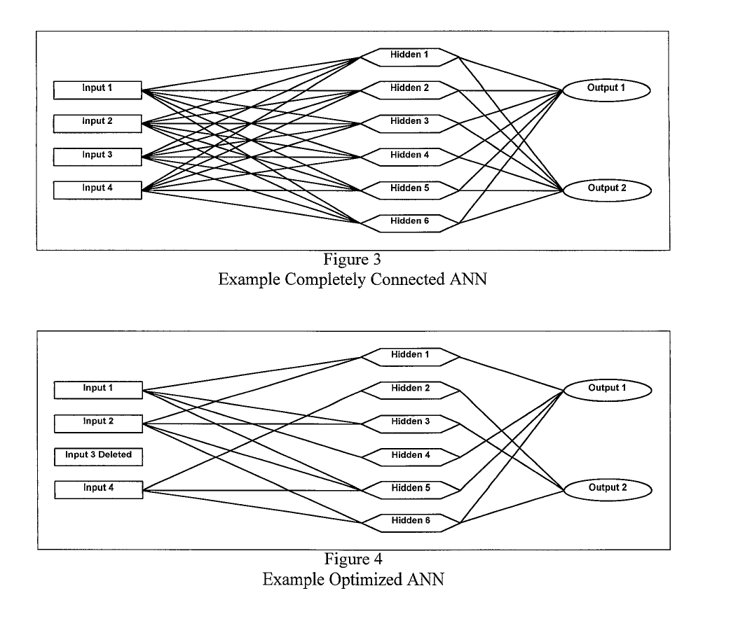

The subject invention provides an automated method for efficiently optimizing ANN inputs and architectures using a genetic algorithm. When designing neural network architectures, users almost always created fully-connected networks as described above, and as shown in FIG. 3. Fully-connected architectures have all possible connections present between neurons of adjacent layers. The actual “intelligence” in ANNs lies in the set of connections and their underlying weights. The actual hidden neurons are really nothing more than convenient connection points for the model. Given the restrictions of traditional ANN training tools, the only control the user has over the connectivity of the network is adding or subtracting completely-connected hidden neurons. Using completely-connected ANNs can also cause problems with performance. Since completely-connected networks will almost always result in unnecessary connections, such ANNs will tend to “over-fit” the data, tending to memorize the training data rather than achieving the desirable ability to generalize about the training data.

The subject invention explicitly recognizes that the intelligence of an ANN is in the connections and not in the neurons. Thus the invention constructs optimally-connected structures as shown in FIG. 4. In this illustrative figure, the third input has been completely dismissed as extraneous, and the remaining nodes have a much more select connectivity.

To construct ANNs as shown in FIG. 4 via an exhaustive search would generally be infeasible. For example, to exhaustively examine all possible connectivities associated with the relatively simple architecture shown FIGS. 3 and 4, all combinations of the 36 possible connections would need to be assessed. In this case, that would require 2³⁶ networks being trained and tested. Assuming an optimistic estimate of one minute per network, this would require over 130,000 years to complete.

The subject invention accomplishes this task in a timely manner by using a genetic algorithm to traverse the search space. The chromosome pattern and fitness function are specifically crafted to allow simultaneous evolution of the input space and the hidden neuron connectivity. In particular, the chromosomes span the entire connectivity space, and allow the representation of any architecture. The fitness function is based on the performance of the ANN corresponding to a given chromosomal pattern, with modifications to encourage spurious input rejection and architecture minimization. Finally, the dynamics of the GA are designed to effectively span the search space and quickly approach the optimal architecture.

### DETAILED DISCLOSURE OF THE INVENTION

Using the information provided in this section, it is possible to construct the invention described in summary above. Generally, the steps to accomplish this are

Construct a genetic algorithm computer module;

Construct an artificial neural network training computer module;

Define a chromosome structure within the GA that corresponds to the desired characteristics of the ANNs; and

Construct a fitness function computer module to be used by the GA, which exercises the ANN training module.

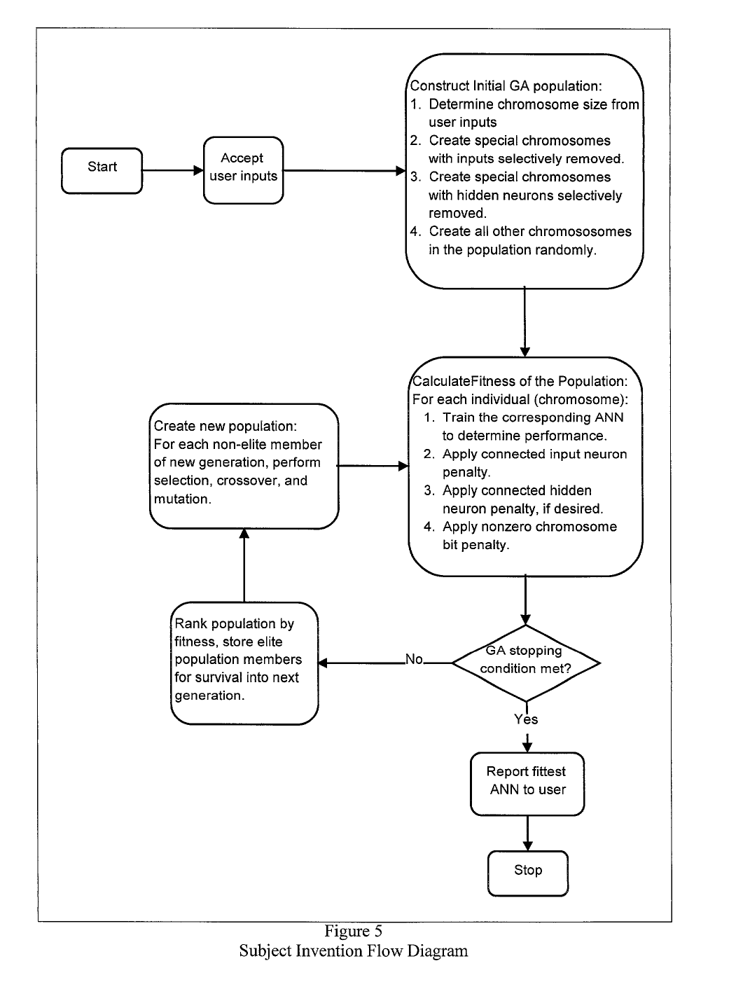

These tools would be compiled to work as either a single entity for solving problems on single computers, or compiled in separate client-server modules to work in a parallel or distributed computing environment. The resulting tool could then be exercised using domain-specific data to capture the knowledge contained in the database. FIG. 5 shows a flow diagram of the algorithm for the invention.

Genetic Algorithm Module

The most critical component of this invention is genetic algorithm, which controls the optimization of the ANN. Many of the aspects of the GA can be determined as a function of the developer's preference, while others must adhere to strict requirements or restrictions. The general GA type is not restricted. This approach has been used successfully using a monolithic (panmictic) population using a generation-synchronous simple genetic algorithm. It has also proven effective using a GA with distributed (polytypic) sub-populations in a non-sychronizing system. Similarly, the method of selection does not seem to be a limiting parameter. This technique has been demonstrated using both tournament and roulette-wheel algorithms for reproductive selection.

To limit the number of ANNs that must actually be trained during the fitness evaluation, it is desirable to construct the population with a modest number of members in the population, but implement a high mutation rate and elitism. This combination will allow fast convergence to an optimized individual in the population at the expense of the average fitness of the population. With a population of 100-200 individuals, a mutation rate of 0.005 to 0.05 (probability of individual bit-flip during crossover), and 5 to 10% elitism, an optimized ANN will usually emerge with after 5000 to 10,000 fitness evaluations. Assuming an average fitness evaluation of one minute, this would correspond to run-times of a few days on a single-CPU system, and much less time on a parallel or distributed computing system.

Finally, since both GAs and ANNs are highly stochastic processes, it will be important for the GA to control the random numbers and seeds that are used for the various random processes. The primary need for this is to maintain repeatability of results, both within a single run, and among several runs.

Artificial Neural Network Training Module

Like the GA module, the ANN module for the invention has aspects that must be tightly controlled, while others aspects allow developers latitude. The particular architecture that must be used is the ubiquitous multi-layer perceptron (MLP). However, there are a large number of high-quality training algorithms available for MLP ANNs, and, for the most part, any will work well here. This method has been successfully tested with the venerable “Backpropagation of Errors” training algorithm, but other methods, such as “Conjugate Gradient Descent,” “Levenberg-Marquardt,” or genetic/evolutionary algorithms will also be effective.

The developer may have to make some modifications to these algorithms as found in popular literature, since most publications assume a fully-connected network. The modifications to allow an arbitrarily connected network are generally straightforward, requiring only indexing changes.

Chromosome Structure

As noted above, chromosomes in GAs are generally binary strings. This pardigm lends itself quite naturally to the subject invention. In particular, each neural connection in an ANN architecture is assigned one bit in the chromosome, and each bit can take the value of either zero or one. A zero value indicates that the connection should not exist in the corresponding ANN, while a value of one indicates that the connection should exist. The size of the chromosome can then be calculated easily. The number of bits in the chromosome (i.e. the chromosome length) will be the total number of possible connections in the corresponding fully connected ANN. For an ANN with a single hidden layer, this will be:

Chromosome Length =(# inputs)*(# hidden)+(# hidden)*(# outputs),

where (# inputs), (# hidden), and (# outputs) correspond to the number of input, hidden, and output neurons, respectively. For ANNs with additional hidden layers, additional product terms will be needed to allow the connections between hidden layers.

In order to allow the GA to discard spurious input neurons, the chromosomes in the invention must be arranged very carefully. The connections from an input neuron to the first hidden layer work together as a “building block,” i.e. they are not independent in terms of the goal of the algorithm. If the bits for these connections were placed arbitrarily within the chromosome, it would be very likely that the process of crossover would split the group of bits for that input up, and quickly eliminate disconnected inputs from the population. Rather, the bits for a single input neuron should be adjacent in the chromosomal structure, to maximize the likelihood that disconnected neuron chromosome sub-structures remain intact during crossover.

With the goal of eliminating spurious input neurons in mind, it is also important to construct the initial population of the GA methodically. In a general GA, each bit position is selected at random, so each initial member of the population is constructed arbitrarily. To maximize the likelihood that spurious inputs will be discarded, the subject invention specifically constructs individuals in the initial population that have inputs completely disconnected. Other connection bits in the chromosome remain arbitrary. Even without explicitly including such specialized individuals in the initial population, it is possible that spurious inputs will be discarded, but convergence is much faster with the biased initial population.

This method is also useful in discarding unneeded hidden neurons. By grouping and individual hidden neuron's connections together for connecting with the subsequent layer in the ANN, and by selectively zeroing the appropriate chromosomal sub-strings during initial population generation, unneeded hidden neurons can also be evolved out of the ANN architecture. In this way, the user can specify a maximum number of hidden neurons be made available to the ANN, and be confident that the invention will reduce the network to a usable minimum. This method works especially well for cases with one hidden layer and one output neuron, which is a very common architecture. In this case, a zero bit for a connection to the output neuron effectively eliminates a hidden neuron from the ANN architecture.

Fitness Function

To determine which members of the population are most fit to reproduce and propagate their chromosomal structure to subsequent generations, a computer module is included in the invention to attach a numeric definition of quality to each chromosome. The primary contributor to the fitness assessment is the accuracy of the neural network that corresponds to the chromosome. Thus the first step in determining fitness is to exercise the ANN training module (described above) to find the accuracy of the ANN architecture for the chromosome being assessed. The accuracy of the neural network can be any of the common performance measures used by ANNs, such as RMS (root-mean-square) error, mean absolute error, ROC (receiver-operator characteristic) curve area, number of correct cases, or any other appropriate metric.

After calculating the primary performance metric, the invention then applies two performance penalties to allow the GA to create a bias towards compact networks with a minimal input set. First, a penalty is extracted for each connected input neuron, to favor networks with fewer attached input neurons. Second, a smaller penalty is made for each bit in the chromosome with a nonzero value. This will bias the GA toward producing ANNs with optimized connections.

These penalties in the invention are in the form of products. If the metric for ANN performance is error, then the GA will attempt to minimize the error, and the penalty factors should be numbers greater than one. Conversely, if ANN performance is measured in number of correct cases or some other positive metric, then the GA will be maximizing the value, and penalty factors should be between zero and one to effectively lower performance. The values of the actual penalty factors will vary from problem to problem, and will be a function of parameters such as chromosome length, number of inputs, and amount of “noise” present in the data set.

### DESCRIPTION OF PREFERRED EMBODIMENTS

To implement the above invention most effectively, several preferred implementation details are presented in this section.

The invention is a method that, when implemented on a computing system, will be a CPU-intensive task. Thus deploying the invention using a fast, compiled computer language rather than a slower interpretive language. While the use of object-oriented techniques is a matter of developer preference, the language should have dynamic memory capabilities to allow efficient deployment of the data structures described in the previous section.

Similarly, the nature of the computing tasks will require a large number of floating point arithmetic calculations. For this reason, the target hardware platform should have a fast floating-point numeric processor.

The modular nature of the invention also lends itself naturally to parallel or distributed processing. In particular, if a panmictic GA is implemented, one node or processor could be dedicated to the GA module, while the other nodes or processors perform serial fitness assessments. For a polytypic GA, each node or processor would have its own sub-population. Using a parallel or distributed computing system would effectively reduce the run-time of the method linearly as a function of the number of available processors.

Finally, one criticism of GAs is that as the algorithm converges on a solution, the same individuals are repeatedly produced by crossover as diversity in the population declines. This is not really a problem, except that the same individuals must be assessed for fitness repeatedly. In the case of this GA application, the fitness function is relatively long-running, as ANNs are being trained during the fitness assessments. Thus it is desirable to construct a data structure to store previously calculated fitnesses. The most CPU efficient way to do this would be with a large static array with one element for each possible ANN configuration. However, for even the simple case in FIGS. 3 and 4, this would require and array with 2³⁶ elements, which in not feasible.

An alternative would be to create a linear linked list, which would be very efficient in terms of memory, but deficient in terms of CPU usage. A large linear linked list generally requires considerable CPU time to be kept in order, and a similar amount of CPU time to search the list.

A good alternative for the subject invention is a dynamic binary linked tree, with one level per chromosome bit. Thus for the case in FIGS. 3 and 4, a tree of depth 36 would be created dynamically. The binary tree consist of binary nodes that “point” to lower binary nodes, and the lower node stores the fitness value. Since the tree is dynamic, nodes are created as they are needed. The binary linked tree is very fast to traverse in search of previously assessed cases, and is reasonably fast to add nodes to as needed. It is not as parsimonious with memory as the simple linear linked list, but it does become more memory efficient for each successive value that is added to the tree, since branch sub-structures are shared among multiple fitness assessments.

What is claimed is:

1. A process for selecting inputs and developing an architecture for an artificial neural network comprised of input neurons and hidden neurons, utilizing a genetic algorithm, and wherein each neural connection of said neural network is assigned one bit in a corresponding chromosome of said genetic algorithm, comprising the steps of:
constructing a population of chromosomes by arranging together on each of the chromosomes of said population contiguous groups of bits corresponding to neural connections associated with the input neurons of said neural network;
further developing said population of chromosomes by arranging together on each of the chromosomes of said population contiguous groups of bits corresponding to neural connections associated with the hidden neurons of said neural network;
assigning values to a first group of bits to allow selective elimination of an input neuron during application of said genetic algorithm;
assigning values to a second group of bits to allow selective elimination of a hidden neuron during application of said genetic algorithm;
calculating fitness of each chromosome in said population; and
evolving the population to further minimize connectivity of remaining neurons in the chromosomal representation.
